(19) United States
(12) Patent Application Publication
(10) Pub. No.: US 2016/0328714 A1
(43) Pub. Date: Nov. 10, 2016

(54) METHOD AND APPARATUS FOR AUTHENTICATING PAYMENT RELATED INFORMATION IN MOBILE COMMUNICATION SYSTEM

(71) Applicant: Samsung Electronics Co., Ltd, Gyeonggi-do (KR)

(72) Inventors: Kiseok Lee, Gyeonggi-do (KR); Daekyu Choi, Gyeonggi-do (KR); Jaeweon Cho, Gyeonggi-do (KR)

(21) Appl. No.: 15/150,202

(22) Filed: May 9, 2016

(30) Foreign Application Priority Data
May 8, 2015 (KR) 10-2015-0064303

(51) Int. Cl. G06Q 20/40; G06Q 20/34; H04W 4/00

(52) U.S. Cl. CPC G06Q 20/4014; H04W 4/005; G06Q 20/409; G06Q 20/34

(57) ABSTRACT

The present disclosure relates to a sensor network, machine type communication (MTC), machine-to-machine (M2M) communication, and technology for Internet of Things (IoT). The present disclosure may be applied to intelligent services on the basis of the above technologies, such as smart home, smart building, smart city, smart car, connected car, health care, digital education, smart retail, security and safety services. A method for authenticating payment related information of an authentication server in a mobile communication system is provided, which includes receiving first authentication information including a terminal identifier and beacon receiver related information from a beacon receiver, receiving second authentication information including subscriber identification information that is mapped onto a user's payment means and payment terminal related information from a payment server in accordance with a user's payment request, and authenticating payment related information through comparison of the first authentication information with the second authentication information.

### CROSS-REFERENCE TO RELATED APPLICATION(S) AND CLAIM OF PRIORITY

The present application is related to and claims benefit under 35 U.S.C. §119(a) of a Korean patent application filed on May 8, 2015, in the Korean Intellectual Property Office and assigned Serial No. 10-2015-0064303, the entire disclosure of which is hereby incorporated by reference.

### TECHNICAL FIELD

The present disclosure relates to a mobile communication system, and more particularly to a method and an apparatus for authenticating payment related information in a mobile communication system.

### BACKGROUND

The Internet, which is a human centered connectivity network where humans generate and consume information, is now evolving to the Internet of Things (IoT) where distributed entities, such as things, exchange and process information. The Internet of Everything (IoE), which is a combination of the IoT technology and big data processing technology through connection with a cloud server, has emerged. As technology elements, such as sensing technology, wired/wireless communication and network infrastructure, service interface technology, and security technology have been demanded for IoT implementation, a sensor network, a Machine-to-Machine (M2M) communication, Machine Type Communication (MTC), and so forth have been recently researched.

Such an IoT environment may provide intelligent Internet Technology (IT) services that create a new value to human life by collecting and analyzing data generated among connected things. The IoT may be applied to a variety of fields including smart home, smart building, smart city, smart car or connected cars, smart grid, health care, smart appliances and advanced medical services through convergence and combination between existing Information Technology (IT) and various industrial applications.

Recently, with the abrupt increase of the diffusion of portable terminals, they have settled down as daily necessaries of the moderns. Since such portable terminals can provide not only inherent voice call services but also various kinds of data transfer services and various additional services, they have been changed to multimedia communication devices in function.

On the other hand, although credit cards are simple and convenient payment means that have been widely used, credit card subscribers may suffer financial damages in the case where such credit cards are lost, burglarized, or copied to be exposed to other people.

Further, if there exists an affiliated concern that is in cooperation with a store in which payment is in progress, a user should take a reserve using a separate reserve credit card in order to receive cooperation benefits to cause inconvenience in use.

Accordingly, there is a need for a method for preventing other people excluding a subscriber from using a credit card through authentication of a credit card user using a portable terminal possessed by the user and a method for automatically creating cooperation benefits in the case where the credit card user is authenticated, and researches for such methods are necessary.

### SUMMARY

To address the above-discussed deficiencies, it is a primary object to provide a method and an apparatus for authenticating a user using a terminal identifier that is transmitted from a mobile communication terminal and user identification information that is mapped onto a payment means and authenticating user's location information using information on a beacon receiver that is located in a payment place (hereinafter referred to as “beacon receiver related information”) and payment terminal related information when the user requests payment.

Another aspect of the present disclosure proposes a method and an apparatus for automatically creating cooperation benefits using cooperation information that is joined by a user in the case where authentication of the user and user's location information is completed for user convenience.

In accordance with an aspect of the present disclosure, a method for authenticating payment related information of an authentication server includes receiving first authentication information including a terminal identifier and beacon receiver related information from a beacon receiver; receiving second authentication information including subscriber identification information that is mapped onto a user's payment means and payment terminal related information from a payment server in accordance with a user's payment request; and authenticating payment related information through comparison of the first authentication information with the second authentication information.

In accordance with another aspect of the present disclosure, a method for authenticating payment related information of a terminal includes encrypting a terminal identifier allocated to the terminal; transmitting the encrypted terminal identifier to a beacon receiver; and receiving the result of authentication from an authentication server, wherein the terminal identifier is used to authenticate a user through comparison of the terminal identifier with subscriber identification information that is transmitted from the authentication server to a payment server, and beacon receiver related information that is transmitted together with the terminal identifier is used to authenticate user's location information through comparison of the beacon receiver related information with payment terminal identification information that is transmitted from the payment server.

In accordance with still another aspect of the present disclosure, an authentication server includes a transceiver configured to transmit and receive signals with another network entity; and a controller configured to receive first authentication information including a terminal identifier and beacon receiver related information from a beacon receiver, to receive second authentication information including subscriber identification information that is mapped onto a user's payment means and payment terminal related information from a payment server in accordance with a user's payment request, and to authenticate payment related information through comparison of the first authentication information with the second authentication information.

In accordance with yet still another aspect of the present disclosure, a terminal includes a transceiver configured to transmit and receive signals with another network entity; and a controller; and a controller configured to encrypt a terminal identifier allocated to the terminal, to transmit the encrypted terminal identifier to a beacon receiver, and to receive the result of authentication from an authentication server, wherein the terminal identifier is used to authenticate a user through comparison of the terminal identifier with subscriber identification information that is transmitted from the authentication server to a payment server, and beacon receiver related information that is transmitted together with the terminal identifier is used to authenticate user's location information through comparison of the beacon receiver related information with payment terminal identification information that is transmitted from the payment server.

According to the aspects of the present disclosure, in the case where the user requests payment using the payment means, the payment related information (user authentication and user's location authentication) is authenticated using the terminal possessed by the user, and thus the financial damage that is caused by the loss, burglary, or copy of the payment means can be prevented. Further, if the payment related information is authenticated, the cooperation benefits are automatically created, and thus user's convenience can be sought.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of the internal configuration of a terminal according to the present disclosure;

FIG. 2 illustrates a block diagram of the internal configuration of an authentication server according to an embodiment of the present disclosure;

FIG. 3 illustrates a diagram explaining a process of authenticating payment related information according to an embodiment of the present disclosure;

FIG. 4 illustrates a flowchart explaining a process of authenticating payment related information according to an embodiment of the present disclosure;

FIG. 5 illustrates a flowchart explaining the operation of a terminal according to an embodiment of the present disclosure;

FIG. 6 illustrates a flowchart explaining the operation of an authentication server according to an embodiment of the present disclosure;

FIG. 7 illustrates a flowchart explaining the operation of a beacon receiver according to an embodiment of the present disclosure;

FIG. 8 illustrates a diagram explaining a process of reserving points in a cooperation server after authentication of payment related information according to another embodiment of the present disclosure; and

FIG. 9 illustrates a flowchart explaining a process of reserving points in a cooperation server after authentication of payment related information according to still another embodiment of the present disclosure.

### DETAILED DESCRIPTION

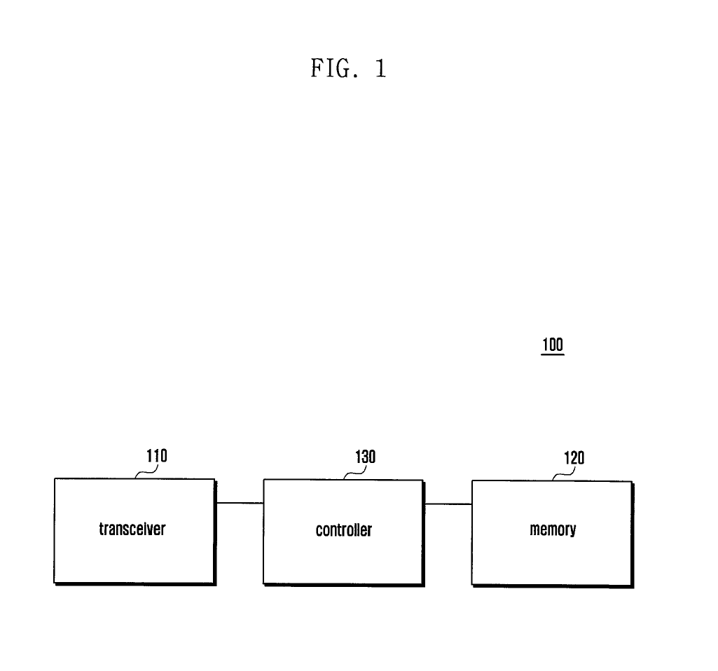

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communication system. Hereinafter, embodiments of the present disclosure will be described in detail with reference to the accompanying drawings.

In describing the embodiments of the present disclosure in the following description, explanation of the technical contents that are well known in the art to which the present disclosure pertains and are not directly related to the present disclosure will be omitted to avoid obscuring the subject matter of the present disclosure and to transfer the same more accurately.

For the same reason, in the accompanying drawings, some constituent elements are exaggerated, omitted, or roughly illustrated. Further, sizes of some constituent elements may not completely reflect the actual sizes thereof. In the drawings, the same drawing reference numerals are used for the same elements across various figures.

The aspects and features of the present disclosure and methods for achieving the aspects and features will be apparent by referring to the embodiments to be described in detail with reference to the accompanying drawings. However, the present disclosure is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the disclosure, and the present disclosure is only defined within the scope of the appended claims. In the entire description of the present disclosure, the same drawing reference numerals are used for the same elements across various figures.

The present disclosure will be described herein with reference to the accompanying drawings illustrating block diagrams and flowcharts for explaining a method and an apparatus for supporting facility control of a terminal according to embodiments of the present disclosure. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Also, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “unit”, as used in an embodiment, means, but is not limited to, a software or hardware component, such as a Field Programmable Gate Array (FPGA) or Application Specific Integrated Circuit (ASIC), which performs certain tasks. However, a unit does not mean that it is limited to software or hardware. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. In addition, components and units may be implemented to reproduce one or more CPUs in a device or a security multimedia card.

FIG. 1 illustrates the internal configuration of a terminal according to the present disclosure.

The term “terminal” used in the description may be called a Mobile Station (MS), User Equipment (UE), User Terminal (UT), wireless terminal, Access Terminal (AT), terminal, subscriber unit, Subscriber Station (SS), wireless device, wireless communication device, Wireless Transmit/Receive Unit (WTRU), mobile node, mobile, or other terms. Various examples of terminals may include a cellular phone, smart phone having wireless communication function, PDA having wireless communication function, wireless modem, portable computer having wireless communication function, photographing device such as a digital camera having wireless communication function, gaming device having wireless communication device, music storage and reproduction appliance having wireless communication function, and Internet appliance capable of performing wireless Internet connection and browsing, and other portable units or terminals integrating combinations of such functions.

As illustrated in FIG. 1, a terminal 100 may include a transceiver 110 configured to transmit and receive signals, a memory 120, and a controller 130.

The transceiver 110 performs data transmission/reception function for wireless communication of the terminal 100. Further, the transceiver 110 may receive data through a wireless channel to output the received data to the controller 130, and may transmit the data that is output from the controller 130 through the wireless channel. Further, the transceiver 110 may perform communication with an electronic device that can perform short-range wireless communication (hereinafter referred to as “electronic device”). The short-range wireless communication may include all kinds of short-range wireless communications, such as Bluetooth®, Zigbee, and Ultra Wide Band (UWB). According to the present disclosure, a beacon receiver is used as an example of an electronic device that can perform the short-range wireless communication, but is not limited thereto. In an embodiment of the present disclosure, the transceiver 110 may transmit an identifier of the terminal in the case where the terminal 100 is located within a predetermined distance from the electronic device.

As the terminal transmits the terminal identifier in the case where the terminal is located within the predetermined distance in which short-range wireless communication becomes possible (e.g., 5 m to 10 m) from the electronic device, it becomes possible to perform authentication of a user more accurately. For example, if a user has lost a credit card, a user's location and a location where payment request using the credit card is made would be different from each other. At this time, in the case where a base station having a wide communication radius is utilized, the user authentication may succeed even though the user's location and the location where the payment request using the credit card is made are different from each other. In contrast, in the case of using an electronic device that can perform short-range communication, the terminal is unable to transmit the terminal identifier to the electronic device capable of performing the short-range wireless communication, which is installed in a place where the payment request is made, and thus user authentication fails. Accordingly, more accurate user authentication becomes possible.

The memory 120 may store the identifier of the terminal according to an embodiment of the present disclosure. The terminal identifier may be inherent information that is allocated to the terminal, and according to the present disclosure, the terminal identifier may be used to authenticate the user. If the terminal 100 approaches an electronic device within a predetermined distance, it may transmit the terminal identifier that is stored in the memory 120 to the electronic device. Further, the memory 120 may store a common key of an authentication server in order to encrypt the terminal identifier.

The controller 130 controls the overall operation of the terminal 100 according to an embodiment of the present disclosure. The controller 130 may be referred to as a processor. If it is determined that the distance between the electronic device and the terminal 100 is within a predetermined distance, the controller 130 may operate to transmit the terminal identifier that is stored in the memory 120 to the electronic device. In this case, the controller 130 may operate to encrypt the terminal identifier and the current time with the common key of the authentication server and may transmit the encrypted terminal identifier and current time to the electronic device.

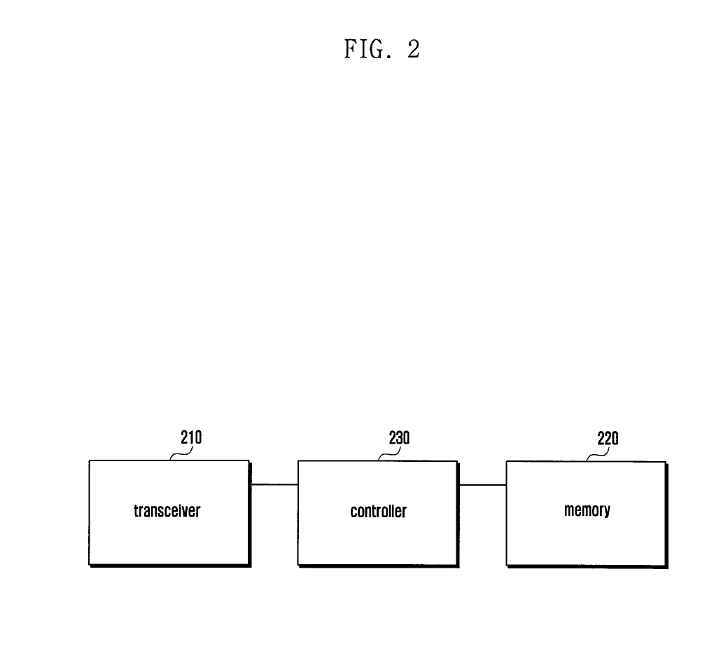

FIG. 2 illustrates the internal configuration of an authentication server according to an embodiment of the present disclosure.

As illustrated in FIG. 2, an authentication server 200 may include a transceiver 210, a memory 220, and a controller 230.

The transceiver 210 may perform communication with a beacon receiver. The transceiver 210 may receive first authentication information including a terminal identifier and beacon receiver related information from the beacon receiver.

The beacon receiver related information may mean an identifier that is inherently allocated to the beacon receiver. Further, the beacon receiver related information may mean location information of the beacon receiver.

If a user's payment request is made, the transceiver 210 may receive second authentication information including subscriber identification information that is mapped onto a payment means and payment terminal related information from a payment server in accordance with the user's payment request.

The subscriber identification information may mean information for identifying a subscriber that is mapped onto a credit card in the case where the payment means is the credit card. In this case, the subscriber identification information may have no relation with personal information for protecting personal information of the subscriber. The subscriber identification information may be mapped onto the terminal identifier to be stored in the authentication server, and may be used to authenticate the user.

The payment terminal related information may mean an identifier that is inherently allocated to a card terminal in the case where the payment terminal is the card terminal. Further, the payment terminal related information may mean location information of the card terminal.

Further, the transceiver 210 may transmit the result of authentication that is acquired using the received first authentication information and second authentication information to the payment server.

According to the present disclosure, the storage 220 may store information for authenticating payment related information. The payment related information may mean user information and user's location information.

Specifically, the memory 220 may store information in which the terminal identifier that is transmitted by the terminal and subscriber identification information are mapped onto each other to authenticate the user. Accordingly, if the terminal identifier and the subscriber identification information are received, the authentication server 200 may authenticate the user through confirmation of whether the terminal identifier and the subscriber identification information are mapped onto each other.

Further, the memory 220 may store information in which the beacon receiver related information and payment terminal related information are mapped onto each other to authenticate the user's location. For example, if the payment terminal related information is the identifier that is inherently allocated to the payment terminal, the memory 220 may store information in which the payment terminal related information and the identifier of the beacon receiver that is installed in the same place as the place of the payment terminal are mapped onto each other. Accordingly, the authentication server 200 may authenticate the user's location through determination of whether the beacon receiver related information and the payment terminal related information are mapped onto each other.

Further, the memory 220 may store the common key that is stored in the terminal 100 and a private key that forms a pair with the common key.

If the first authentication information is received from the beacon receiver, the controller 230 may decrypt the terminal identifier that is included in the authentication information using the private key stored in the memory 220. The controller 230, which has decrypted the terminal identifier, may authenticate the user through determination of whether the decrypted terminal identifier and the subscriber identification information that is received from the payment server are mapped onto each other.

Further, the controller 230 may authenticate the user's location through determination of whether the beacon receiver related information that is included in the first authentication information and the payment terminal related information that is included in the second authentication information are mapped onto each other.

Accordingly, if it is determined that the received terminal identifier and the subscriber identification information are mapped onto each other and the received beacon receiver related information and the payment terminal related information are mapped onto each other, the controller 230 may determine that the authentication of the user and the user's location (hereinafter referred to as “payment related information”) has succeeded, and may operate to transmit an authentication success message to a card company server.

In contrast, if any one of the payment related information has not been authenticated, the controller 230 determines that the authentication has failed, and may transmit an authentication failure message to the card company server.

The controller 230 may be referred to as a processor.

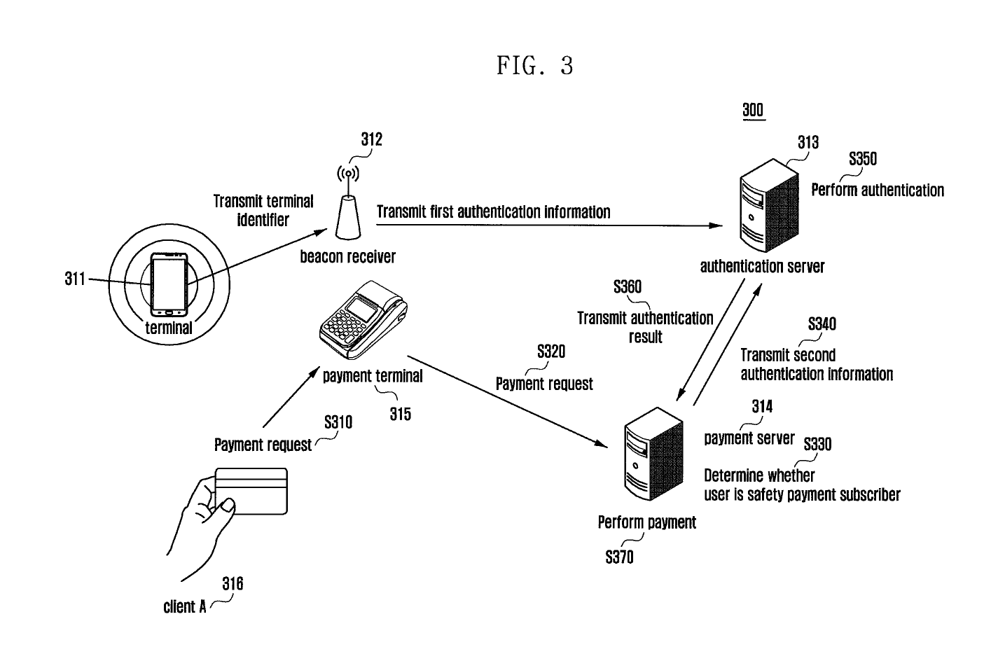

FIG. 3 illustrates a diagram explaining a process of authenticating payment related information according to an embodiment of the present disclosure.

Referring to FIG. 3, a terminal 311 that is possessed by a user may perform communication with a beacon receiver 312.

If the terminal 311 is located within a communicable distance from the beacon receiver 312, the terminal 311 may transmit a terminal identifier to the beacon receiver 312. Further, in order to protect user's private information, the terminal 311 may encrypt the terminal identifier using the current time and a common key of an authentication server to transmit the encrypted terminal identifier to the beacon receiver 312. Further, the terminal 311 may periodically encrypt the terminal identifier to transmit the encrypted terminal identifier.

The terminal periodically encrypts the terminal identifier using the current time is to prevent replay attack. A replay attack may be an attack under pretense of a rightful user through selecting and copying a valid message on a protocol and then retransmitting the copied message later. Accordingly, the terminal may periodically transmit the changed terminal identifier through encryption of the terminal identifier using the current time.

The beacon receiver 312 that has received the terminal identifier may transmit first authentication information in which beacon receiver related information is added to the terminal identifier to an authentication server 313. The beacon receiver 312 may be installed in a payment place, and the authentication server may confirm whether a user who has requested payment is in the payment place using the beacon receiver related information (authentication of user's location information).

Further, whenever the terminal identifier is newly received from the terminal, the beacon receiver 312 may include the beacon receiver related information in the received terminal identifier to transmit the information to the authentication server 313. Further, the beacon receiver 312 may transmit the first authentication information to the authentication server 313 in accordance with a predetermined period.

The authentication server 313 may perform authentication of the payment related information using the received first authentication information.

If the terminal is located within a predetermined distance from the beacon receiver, the authentication server 313 may periodically receive the first authentication information, and after a predetermined time elapses, the authentication server 313 may be set to be unable to use the information. Further, if a user's payment request is made, the authentication server 313 may authenticate the payment related information using the first authentication information.

Specifically, if a user 316 requests payment using a payment means at operation S310, a payment terminal 315 that has recognized the payment means may transmit the payment request to a payment server 314 at operation S320. In this case, the payment terminal 315 may include payment means information (e.g., credit card information) and payment terminal related information (e.g., card terminal related information) in the payment request to transmit the information to the payment server 314.

At operation S330, the payment server 314 that has received the payment request confirms whether the user who has requested the payment is a safety payment subscriber. That is, the payment server 314 determines whether authentication of the payment related information is required with respect to the payment request. If it is determined that the user is not the safety payment subscriber (authentication is not necessary), the payment server determines whether the payment is possible using the credit card and performs the payment.

In contrast, if it is determined that the user is the safety payment subscriber (authentication is required), the payment server 314, at operation S340, transmits information that is required to authenticate the payment related information to the authentication server 313.

Specifically, in the payment server 314, the subscriber identification information may be mapped in accordance with the payment means. For example, in the case where the user requests the payment using the credit card, subscriber information may be mapped onto the credit card number in the payment server 314. The subscriber information may mean an identifier that is given to identify the subscriber. Accordingly, the payment server 314 may acquire the subscriber identification information using the received payment means information.

Accordingly, the payment server 314 may transmit second authentication information including the received payment terminal related information and the acquired subscriber identification information to the authentication server 313 together with the authentication request.

The authentication server that has received the authentication request from the payment server, at operation S350, may authenticate the payment related information. The process of authenticating the payment related information may include the process of authenticating the user and the process of authenticating the user's location.

Specifically, the authentication server 313 authenticates the user through comparison of the terminal identifier that is included in the first authentication information with the subscriber identification information that is included in the second authentication information. As described above, the authentication server 313 may store information in which the terminal identifier and the subscriber identification information are mapped onto each other. Accordingly, the authentication server 313 may authenticate the user through determination of whether the received terminal identifier and the subscriber identification information are mapped onto each other.

Further, the authentication server 313 may authenticate the user's position through comparison of the beacon receiver related information that is included in the first authentication information with the payment terminal related information that is included in the second authentication information. For example, the beacon receiver related information and the payment terminal related information may be information indicating location information of the beacon receiver and the payment terminal. If so, the authentication server 313 may authenticate the user's location through determination of whether the location information of the beacon receiver is equal to the location information of the payment terminal. Further, the beacon receiver related information and the payment terminal related information may be information of the beacon receiver identifier and information of the payment terminal identifier, respectively. In this case, information in which the beacon receiver related information and the payment terminal related information are mapped onto each other may be stored in the authentication server 313, and the authentication server 313 may authenticate the user's location through determination of whether the received beacon receiver related information and the payment terminal related information are mapped onto each other.

The reason why to authenticate the user and the user's location is to prevent damages in the case where the user's payment means is lost, burglarized, or copied. For example, if the user's payment means is burglarized, the place where the payment request is made using the payment means and the place where the user's terminal is located may be different from each other. However, the authentication server may receive the terminal identifier of the user terminal through the beacon receiver that is installed in the place that is different from the place where the payment request is made at the same time. Accordingly, the authentication server may determine that the user authentication has succeeded and may approve the payment to cause a problem to occur.

Accordingly, the above-described problem can be prevented through performing of not only the user authentication but also the authentication of whether the user's location is the same as the location where the payment request is made.

At operation S360, the authentication server that has authenticated the payment related information at operation S350 may transmit the result of authentication to the payment server 314.

In this case, if the terminal identifier included in the first authentication information and the subscriber identification information included in the second authentication information are mapped onto each other (user authentication) and the beacon receiver related information included in the first authentication information and the payment terminal related information included in the second authentication information are mapped onto each other (user's location information authentication), the authentication server may transmit an authentication success message. In contrast, if authentication of any one of the user authentication and the user's location information authentication has failed, the authentication server transmits an authentication failure message to the payment server 314.

At operation S370, the payment server 314 that has received the result of authentication performs the payment in accordance with the result of the authentication. If the authentication has succeeded, the payment server may perform the payment. In contrast, if the authentication has failed, the payment server may reject the payment.

Further, the authentication server may transmit the result of the authentication to the terminal 311. The user who has received the result of the authentication through the terminal may reject the payment in the case where the payment is not requested by the user himself/herself, and thus the damage that is caused by the loss, burglary, or copy of the payment means can be prevented from occurring.

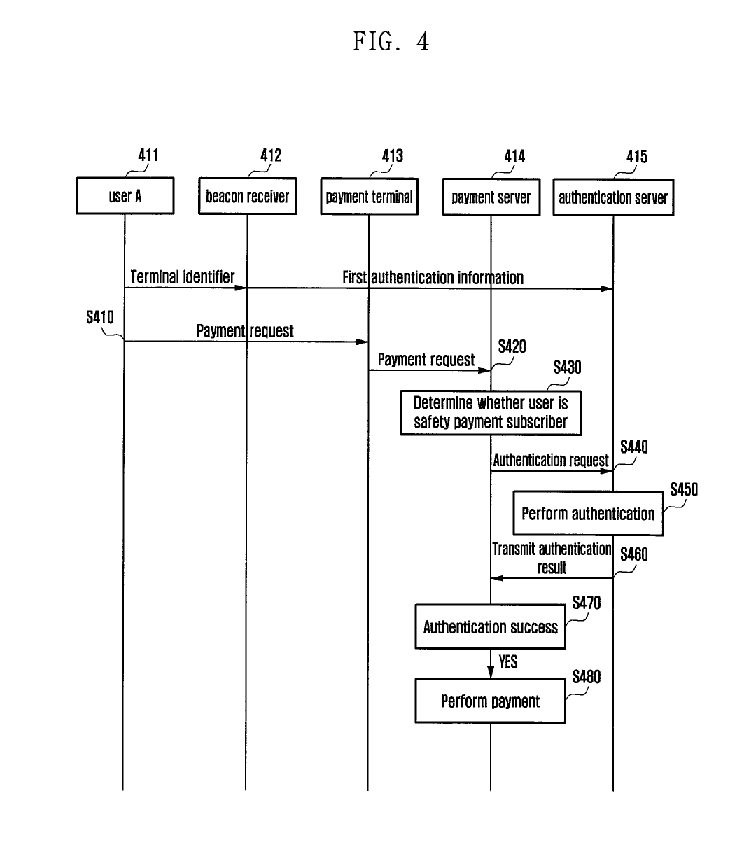

FIG. 4 illustrates a flowchart explaining a process of authenticating payment related information according to an embodiment of the present disclosure.

Referring to FIG. 4, a terminal 411 that is possessed by a user A may perform communication with an electronic device that can perform short-range wireless communication. In this embodiment, an example of the electronic device that can perform the short-range wireless communication may be a beacon receiver 412.

If the terminal 411 is located within a predetermined distance from the beacon receiver 412, the terminal 411 may transmit a terminal identifier that is set to an inherent value in the terminal 411 to the beacon receiver 412. For example, if the user enters into a store B, the user's terminal 411 may transmit the terminal identifier to the beacon receiver 412 that is installed in the store. In this case, in order to protect private information, the terminal 411 may encrypt the terminal identifier using the current time and a common key of an authentication server, and may transmit the encrypted terminal identifier to the beacon receiver 412. Further, the terminal 411 may periodically transmit the encrypted terminal identifier to the beacon receiver 412.

The reason why the terminal periodically encrypts the terminal identifier using the current time is to prevent replay attack. The replay attack means an attack under pretense of a rightful user through selecting and copying a valid message on a protocol and then retransmitting the copied message later. Accordingly, the terminal may periodically transmit the changed terminal identifier through encryption of the terminal identifier using the current time.

The beacon receiver 412 that has received the terminal identifier may transmit first authentication information in which beacon receiver related information is included in the terminal identifier to an authentication server 415. The beacon receiver 412 may be installed in a payment place as a device for authenticating the user's location. Accordingly, the authentication server 415 that has received the first authentication information may be aware of the fact that the terminal is located in the store B.

Further, whenever the terminal identifier is received, the beacon receiver 412 may transmit the first authentication information including the received terminal identifier to the authentication server 415. Further, the beacon receiver 412 may transmit the first authentication information to the authentication server 415 in accordance with a predetermined period. Further, since the terminal identifier included in the first authentication information is encrypted using the current time and is periodically transmitted, the authentication server 415 may be set to be unable to use the first authentication information if a predetermined time elapses after the first authentication information is received.

If the user enters into the store B, the beacon receiver 412 that is located in the store B transmits the first authentication information including the user's terminal identifier to the authentication server 415 periodically or in accordance with a predetermined pattern.

Thereafter, if the user requests payment at operation S410, a payment terminal 413 that has received the payment request may transmit the payment request to a payment server 414 at operation 420. During the payment request, the payment terminal 413 may transmit payment means information (e.g., credit card number) included in the user's payment means (e.g., credit card) and payment terminal related information to the payment server 414.

The payment terminal related information may be configured in various types. The payment terminal related information may be configured as the same identifier as the identifier of the beacon receiver related information that is installed in the store B. Further, the payment terminal related information may include location information of the store B. Further, the payment terminal related information may mean the identifier of the payment terminal.

Further, the payment terminal related information may be mapped onto the beacon receiver related information to be stored in the authentication server 415.

At operation S430, the payment server 414 that has received the payment request confirms whether the user who has requested the payment is a safety payment subscriber. If the user is not the safety payment subscriber, the authentication is not required, and the payment server 414 performs the payment.

In contrast, if it is determined that the user is the safety payment subscriber, the authentication of the payment related information is required, and the payment server 414 may request the authentication from the authentication server at operation S440.

Further, the payment server 414 may transmit second authentication information including the acquired subscriber identification information and the payment terminal related information to the authentication server 415 together with the authentication request using the received payment means information at step S420.

Specifically, the payment server 414 may store information in which the payment means information and the subscriber identification information are mapped onto each other, and may acquire the subscriber identification information through the received payment means information. Accordingly, the payment server 414 may transmit the second authentication information in which the payment terminal related information is added to the acquired subscriber identification information to the authentication server 415 together with the authentication request at operation S440.

The authentication server 415 that has received the authentication request may perform authentication at operation S450. The authentication server 415 may perform authentication through comparison of the first authentication information that is periodically received from the beacon receiver 412 with the second authentication information that is received from the payment server 414.

The method for authenticating payment related information through the authentication server 415 determines whether the user who has requested the payment is a legal owner of the payment means (user authentication) using the terminal identifier included in the first authentication information and the subscriber identification information included in the second authentication information. Specifically, since the terminal identifier and the subscriber identification information are mapped onto each other in the authentication server 415, the authentication server determines whether the user who has requested the payment is the legal owner of the payment means through determination of whether the received terminal identifier and the subscriber identification information are mapped onto each other.

Further, the authentication server 415 determines whether the place where the user's terminal is located is the same as the place where the payment request is made (user's location information authentication) using the beacon receiver related information included in the first authentication information and the payment terminal related information included in the second authentication information.

For example, if the beacon receiver related information and the payment terminal related information have the same identifier or correspond to information indicating the location information of the store, the authentication server 415 determines whether the beacon receiver related information and the payment terminal related information are the same. Further, even if the beacon receiver related information and the payment terminal related information are not the same, the authentication server may authenticate the user's location through determination of whether they are mapped onto each other in the authentication server.

That is, if the beacon receiver related information and the payment terminal related information are the same or are mapped onto each other, the authentication server may determine that the place where the user's terminal is located and the place where the payment request is made are the same.

If both the user authentication and the user's location authentication have succeeded, the authentication server 415 determines that the authentication has succeeded, whereas if any one of the user authentication and the user's location authentication has failed, the authentication server 415 determines that the authentication has failed.

At operation S460, the authentication server 415 may transmit the result of the authentication to the payment server 414.

The payment server 414 confirms whether the authentication has succeeded at operation S470, and if the authentication has succeeded, the payment server 414 performs the payment at operation S480.

In contrast, if the authentication has failed, the payment server 414 may reject the payment.

Further, the authentication server may transmit the result of the authentication to the terminal. The user who has received the result of the authentication through the terminal may reject the payment in the case where the payment is not requested by the user himself/herself, and thus the damage that is caused by the loss, burglary, or copy of the payment means can be prevented from occurring.

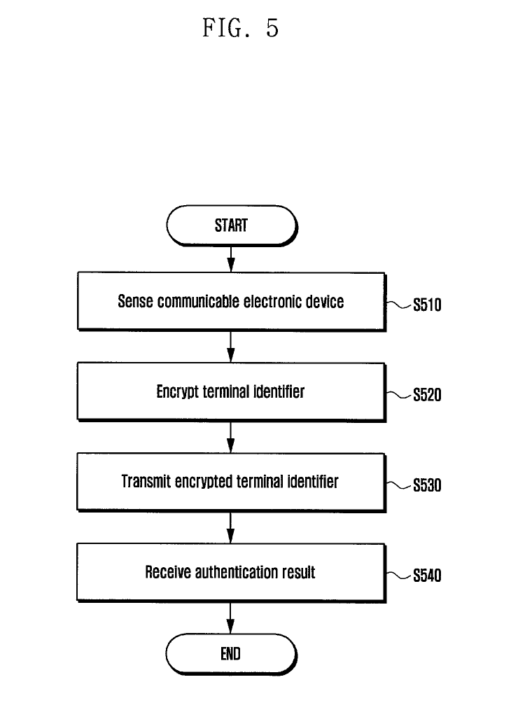

FIG. 5 illustrates a flowchart explaining the operation of a terminal according to an embodiment of the present disclosure.

Referring to FIG. 5, at operation S510, a terminal may sense a communicable electronic device.

At operation S520, the terminal that has sensed the communicable electronic device may encrypt a terminal identifier. In order to protect the terminal identifier against opening to the public, the terminal encrypts the terminal identifier using the current time and a public key of an authentication server.

At operation S530, the terminal that has encrypted the terminal identifier may transmit the encrypted terminal identifier to the sensed electronic device. The terminal identifier that is transmitted to the electronic device may be included in first authentication information to be transmitted to the authentication server, and may be used for user authentication.

Further, the terminal may periodically transmit the terminal identifier to the electronic device, and the terminal identifier may be periodically transmitted to the authentication server together with electronic device related information (hereinafter referred to as beacon receiver related information).

The terminal identifier that is transmitted to the authentication server may be used to authenticate the user together with subscriber identification information that is transmitted from a payment server to the authentication server, and the beacon receiver related information may be used to authenticate the user's location together with payment terminal related information that is transmitted from the payment server to the authentication server.

At operation S540, the terminal that has transmitted the terminal identifier may receive the result of authentication from the authentication server. As the terminal receives the result of authentication from the authentication server, the user can determine whether payment request is made, and if the payment request is not requested by the user himself/herself, the user may reject the payment with respect to the result of the authentication. However, it is not essential that the terminal receives the result of the authentication, and the authentication server may transmit the result of the authentication only to the payment server without transmitting the result of the authentication to the terminal.

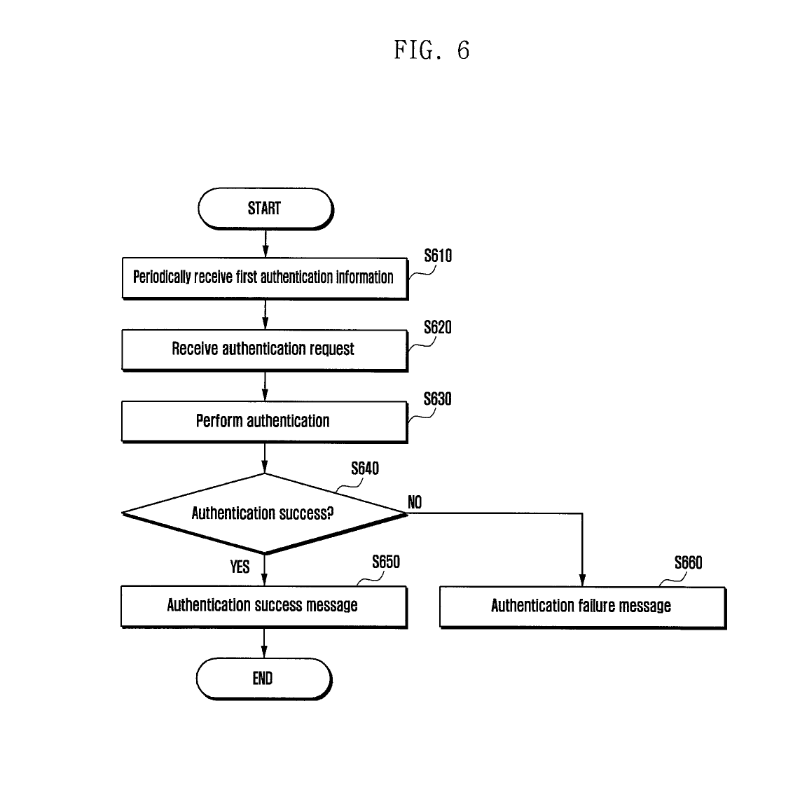

FIG. 6 illustrates a flowchart explaining the operation of an authentication server according to an embodiment of the present disclosure.

Referring to FIG. 6, at operation S610, the authentication server may periodically receive first authentication information. The first authentication information may include a terminal identifier and beacon receiver related information. Further, since a terminal periodically transmits the terminal identifier, an electronic device that has received the terminal identifier from the terminal may periodically transmit the first authentication information including the terminal identifier at a time when the electronic device receives the terminal identifier.

At operation S620, the authentication server that has received the first authentication information may receive an authentication request from a payment server. The authentication request may include second authentication information. If a payment request is made, the second authentication information may include subscriber identification information that is mapped onto a payment means and payment terminal related information.

At operation S630, the authentication server that has received the authentication request may perform authentication of the payment related information. The authentication server may perform the authentication of the payment related information using the first authentication information periodically received and the second authentication information included in the authentication request. The authentication of the payment related information includes user authentication for determining whether a user who has requested the payment is a legal owner of the payment means and user's location information authentication for determining whether a place where the payment request is made and a place where the terminal is located are the same.

Specifically, the authentication server determines whether the user who has requested the payment is the legal owner of the payment means using the terminal identifier included in the first authentication information recently received and the subscriber identification information included in the second authentication information. The terminal identifier and the subscriber identification information may be mapped onto each other in the authentication server, and the authentication server may determine whether the received terminal identifier and the subscriber identification information are mapped onto each other.

Further, the authentication server determines whether the beacon receiver related information included in the first authentication information coincides with the payment terminal related information included in the second authentication information. If the payment terminal related information and the beacon receiver related information use the same identifier, the authentication server may determine whether the beacon identifier coincides with a payment place identifier. For example, the beacon receiver related information may include the identifier of the beacon receiver, and even the payment terminal related information may include the same beacon receiver identifier. Further, both the beacon receiver related information and the payment terminal related information may include location information of the beacon receiver and the place where the payment terminal is located.

In contrast, if the payment terminal related information and the beacon receiver related information include the payment terminal identifier and the beacon receiver identifier, respectively, the payment terminal related information and the beacon receiver related information may be mapped onto each other in the authentication server. Accordingly, the authentication server may perform the authentication of the user's location through determination of whether the beacon receiver related information included in the first authentication information is mapped onto the payment terminal related information included in the second authentication information.

Thereafter, at operation S640, the authentication server that has authenticated the payment related information determines whether the authentication has succeeded.

If the terminal identifier included in the first authentication information and the subscriber identification information included in the second authentication information are mapped onto each other, and the beacon receiver related information included in the first authentication information and the payment terminal related information included in the second authentication information coincide with each other or are mapped onto each other in the authentication server as the result of the authentication, the authentication server determines that the authentication has succeeded.

Accordingly, at operation S650, the authentication server may transmit an authentication success message to the payment server, and the payment server may perform the payment.

In contrast, if the terminal identifier included in the first authentication information and the subscriber identification information included in the second authentication information are not mapped onto each other, or the beacon receiver related information included in the first authentication information and the payment terminal related information included in the second authentication information are not mapped onto each other as the result of the authentication, the authentication server determines that the authentication has failed.

Accordingly, at operation S660, the authentication server may transmit an authentication failure message to the payment server, and the payment server may reject the payment.

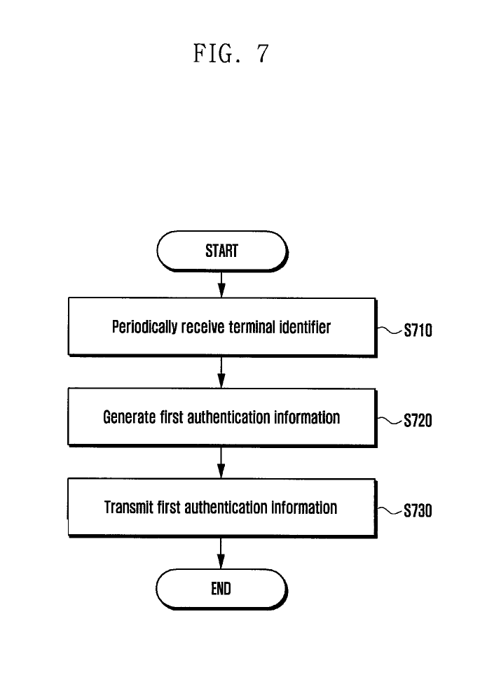

FIG. 7 illustrates a flowchart explaining the operation of a beacon receiver according to an embodiment of the present disclosure.

At operation S710, a transceiver of a beacon receiver may periodically receive a terminal identifier from a terminal.

After receiving the terminal identifier, at operation S720, a controller of the beacon receiver may generate first authentication information in which beacon receiver related information is included in the received terminal identifier. The beacon receiver related information may mean an identifier that is inherently allocated to the beacon receiver. Further, the beacon receiver related information may mean location information of the beacon receiver. However, the beacon receiver related information is not limited to the contents as described above.

At operation S730, the beacon receiver that has generated the first authentication information may transmit the generated first authentication information to an authentication server. In this case, the time when the beacon receiver transmits the first authentication information may be the time when the terminal identifier is received or the time after a predetermined time elapses from the time when the terminal identifier is received. Further, the beacon receiver may transmit the first authentication information in accordance with a predetermined period.

The beacon receiver may transmit the first authentication information to the authentication server until the terminal identifier is not received any more. If the terminal identifier is not received any more, the beacon receiver terminates the transmission of the first authentication information.

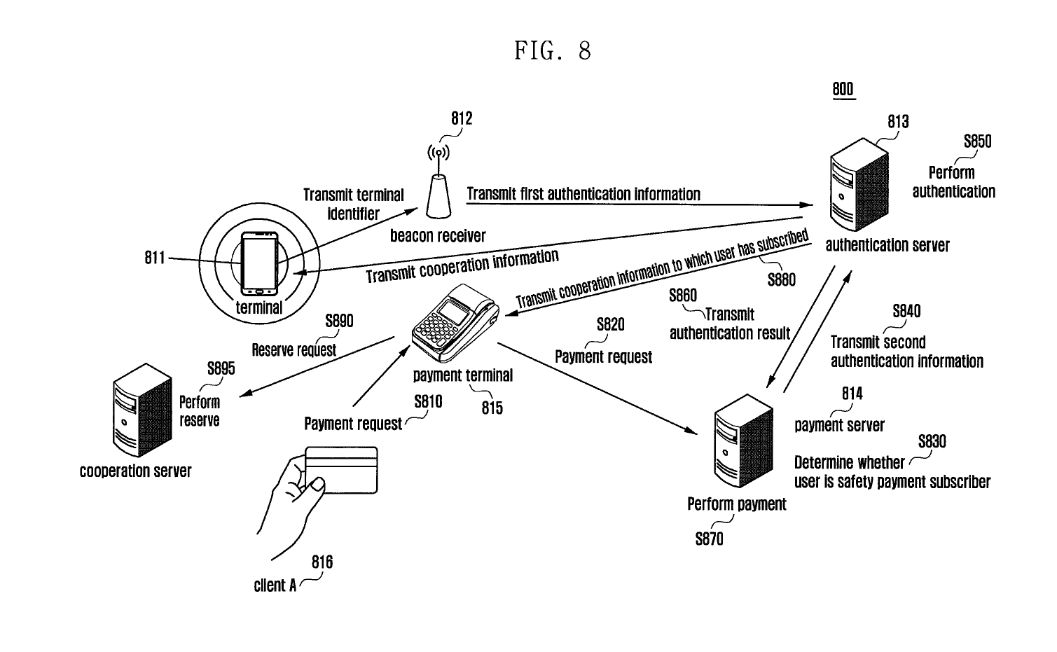

FIG. 8 illustrates a diagram explaining a process of reserving points in a cooperation server after authentication of payment related information according to another embodiment of the present disclosure.

Referring to FIG. 8, an authentication server 813 may receive first authentication information including a terminal identifier and beacon receiver related information from a beacon receiver 812 and second authentication information including subscriber identification information and payment terminal related information from a card company server or payment server 814, and may perform user authentication and user's location information authentication. The authentication process is the same as that as described above with reference to FIG. 3, and thus the duplicate explanation thereof will be omitted.

However, in FIG. 8, the authentication server 813 may transmit cooperation information that corresponds to the beacon receiver related information included in the first authentication information to the terminal 811 after receiving the first authentication information. The authentication server 813 may store the cooperation information that corresponds to the beacon receiver related information. Further, the cooperation information may be included in the first authentication information to be transmitted to the authentication server 813. The cooperation information may include discount information and reserve information in a store in which the beacon receiver 812 is located (hereinafter referred to as “corresponding store”). As the terminal 811 receives the cooperation information, it can confirm the cooperation information and the discount information of the corresponding store. Accordingly, a user can receive discount benefits during payment through pre-confirmation of the discount information or the like.

Then, at operation S850, the authentication server 813 that has performed the authentication determines whether cooperation information to which the user has subscribed exists in the corresponding store in the case where the authentication of the payment related information has succeeded. In this case, cooperation information that is mapped onto the terminal identifier or the subscriber identification information may be included in the authentication server 813. Accordingly, if there exists the cooperation information to which the user has subscribed in the corresponding store, at operation S880, the authentication server 813 may transmit the cooperation information to which the user has subscribed to the payment terminal 815 in operation s880.

At operation S890, the payment terminal 815 that has received the cooperation information requests a reserve from a cooperation server. At operation S895, the cooperation server that has received the reserve request performs point reserve with respect to the subscriber. However, the point reserve is merely an example of cooperation benefits, and the cooperation benefits may occur in various types, such as discount and the like. If the cooperation benefits are automatically created simultaneously with the payment as described above, it is not required to separately present a cooperation card, and thus user convenience can be improved.

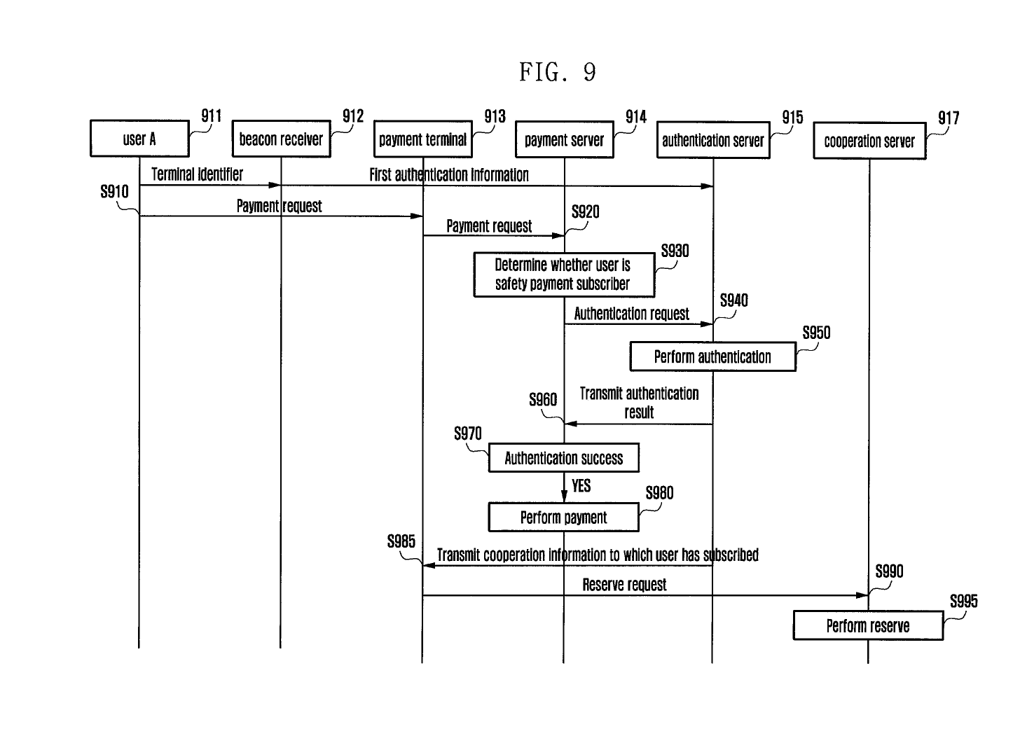

FIG. 9 illustrates a flowchart explaining a process of reserving points in a cooperation server after authentication of payment related information according to still another embodiment of the present disclosure.

Referring to FIG. 9, an authentication server 915 may receive first authentication information including a terminal identifier and beacon receiver related information from a beacon receiver 912 and second authentication information including subscriber identification information and payment terminal related information from a card company server, and may perform user authentication and user's location information authentication. The authentication process is the same as that as described above with reference to FIG. 3, and thus the duplicate explanation thereof will be omitted.

However, as described above with reference to FIG. 8, the authentication server 915 may transmit cooperation information that corresponds to the beacon receiver related information included in the first authentication information to the terminal after receiving the first authentication information. The authentication server 915 may store the cooperation information that corresponds to the beacon receiver related information. Further, the cooperation information may be included in the first authentication information to be transmitted to the authentication server 915. The cooperation information may include discount information and reserve information in a store in which the beacon receiver is located. As the terminal 911 receives the cooperation information, it can confirm the cooperation information and the discount information of the corresponding store. Accordingly, a user can receive discount benefits during payment through pre-confirmation of the discount information or the like.

Then, at operation S950, the authentication server 915 that has performed the authentication determines whether cooperation information subscribed by the user exists in the corresponding store in the case where the authentication of the payment related information has succeeded. In this case, cooperation information that is mapped onto the terminal identifier or the subscriber identification information may be included in the authentication server 915. Accordingly, if there exists the cooperation information to which the user has subscribed in the corresponding store, at operation S985, the authentication server 915 may transmit the cooperation information to which the user has subscribed to the payment terminal 913.

At operation S990, the payment terminal 913 that has received the cooperation information requests a reserve from a cooperation server 917. At operation S995, the cooperation server 917 that has received the reserve request performs point reserve, and thus the point reserves can be automatically performed simultaneously with the payment.

For example, it is assumed that the corresponding store is in cooperation with company A, company B, and company C, and the subscriber has subscribed to company A only. The authentication server grasps that the user has subscribed to company A among company A, company B, and company C that are in cooperation with the corresponding store, and then may transmit the cooperation information to which the user has subscribed at operation 990.

The payment terminal 913 that has received the cooperation information requests user's point reserve from the cooperation server 917, and the cooperation server 917 that has received the reserve request performs the reserve for the user at operation S995.

However, the point reserve is merely an example of cooperation benefits, and the cooperation benefits may occur in various types, such as discount and the like.

After the authentication is completed, the reserve process may be performed simultaneously with the payment or after the payment. As described above, the points are automatically reserved to the cooperation company to which the user has subscribed during the payment even though the user does not present the cooperation card, and thus user convenience can be improved.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method by an authentication server, the method comprising:
receiving first authentication information including a terminal identifier and beacon receiver related information from a beacon receiver;
receiving second authentication information including subscriber identification information that is mapped onto a user's payment means and payment terminal related information from a payment server in accordance with a user's payment request; and
authenticating payment related information through comparison of the first authentication information with the second authentication information.

2. The method of claim 1, wherein the authenticating comprises comparing the terminal identifier included in the first authentication information with the subscriber identification information included in the second authentication information, and comparing the beacon receiver related information included in the first authentication information with the payment terminal related information included in the second authentication information.

3. The method of claim 2, wherein information in which the terminal identifier and the subscriber identification information are mapped onto each other and information in which the beacon receiver related information and the payment terminal related information are mapped onto each other are pre-stored in the authentication server.

4. The method of claim 1, wherein the receiving comprises periodically receiving the first authentication information in the case where the terminal is located within a predetermined distance from the beacon receiver.

5. The method of claim 3, further comprising transmitting an authentication success message to the payment server in the case where the terminal identifier included in the first authentication information is mapped onto the subscriber identification information included in the second authentication information and the beacon receiver related information included in the first authentication information is mapped onto the payment terminal related information included in the second authentication information.

6. A method by terminal, the terminal comprising:
transmitting an encrypted terminal identifier to a beacon receiver; and
receiving the result of authentication from an authentication server,
wherein the terminal identifier is used to authenticate a user through comparison of the terminal identifier with subscriber identification information that is transmitted from a payment server to the authentication server, and beacon receiver related information that is transmitted together with the terminal identifier is used to authenticate user's location information through comparison of the beacon receiver related information with payment terminal identification information that is transmitted from the payment server.

7. The method of claim 6, wherein information in which the terminal identifier and the subscriber identification information are mapped onto each other and information in which the beacon receiver related information and the payment terminal related information are mapped onto each other are pre-stored in the authentication server.

8. The method of claim 6, wherein the terminal identifier is periodically transmitted to the beacon receiver in the case where the terminal is located within a predetermined distance from the beacon receiver.

9. The method of claim 7, wherein payment is approved in the case where the terminal identifier is mapped onto the subscriber identification information and the beacon receiver related information is mapped onto the payment terminal related information.

10. An authentication server, the authentication server comprising:
a transceiver configured to transmit and receive signals with another network entity; and
a controller configured to:
receive first authentication information including a terminal identifier and beacon receiver related information from a beacon receiver;
receive second authentication information including subscriber identification information that is mapped onto a user's payment means and payment terminal related information from a payment server in accordance with a user's payment request; and
authenticate payment related information through comparison of the first authentication information with the second authentication information.

11. The authentication server of claim 10, wherein the controller operates to compare the terminal identifier included in the first authentication information with the subscriber identification information included in the second authentication information and to compare the beacon receiver related information included in the first authentication information with the payment terminal related information included in the second authentication information.

12. The authentication server of claim 11, wherein information in which the terminal identifier and the subscriber identification information are mapped onto each other and information in which the beacon receiver related information and the payment terminal related information are mapped onto each other are pre-stored in the authentication server.

13. The authentication server of claim 10, wherein the controller operates to periodically receive the first authentication information in the case where the terminal is located within a predetermined distance from the beacon receiver.

14. The authentication server of claim 12, wherein the controller operates to transmit an authentication success message to the payment server in the case where the terminal identifier included in the first authentication information is mapped onto the subscriber identification information included in the second authentication information and the beacon receiver related information included in the first authentication information is mapped onto the payment terminal related information included in the second authentication information.

15. A terminal, the terminal comprising:
a transceiver configured to transmit and receive signals with another network entity; and
a controller configured to transmit an encrypted terminal identifier to a beacon receiver, and to receive the result of authentication from an authentication server,
wherein the terminal identifier is used to authenticate a user through comparison of the terminal identifier with subscriber identification information that is transmitted from a payment server to the authentication server, and beacon receiver related information that is transmitted together with the terminal identifier is used to authenticate user's location information through comparison of the beacon receiver related information with payment terminal identification information that is transmitted from the payment server.

16. The terminal of claim 15, wherein information in which the terminal identifier and the subscriber identification information are mapped onto each other and information in which the beacon receiver related information and the payment terminal related information are mapped onto each other are pre-stored in the authentication server.

17. The terminal of claim 15, wherein the terminal identifier is periodically transmitted to the beacon receiver in the case where the terminal is located within a predetermined distance from the beacon receiver.

18. The terminal of claim 16, wherein payment is approved in the case where the terminal identifier is mapped onto the subscriber identification information and the beacon receiver related information is mapped onto the payment terminal related information.
